(19) United States
(12) Patent Application Publication
(10) Pub. No.: US 2008/0054628 A1
(43) Pub. Date: Mar. 6, 2008

(54) Plastic shielding for insulation

(76) Inventor: David R. Beck, Bellevue, WA (US)

Correspondence Address: BLACK LOWE & GRAHAM, PLLC, 701 FIFTH AVENUE, SUITE 4800, SEATTLE, WA, 98104, US

(21) Appl. No.: 10/913,785

(22) Filed: Aug. 7, 2004

Related U.S. Application Data
(60) Provisional application No. 60/493,580, filed on Aug. 7, 2003.

(51) Int. Cl. F16L 59/147

(52) U.S. Cl. 285/47

(57) ABSTRACT

An insulation shield for covering insulation disposed about a pipe includes an elongated body extending along a longitudinal axis between a first end and a second end. The elongated body includes a cylindrical tube wall extending along the longitudinal axis between the first end and the second end. The tube wall has an outer surface and an inner surface. The inner surface defines an elongated channel adapted to receive pipe insulation tubing. A slit extends from the first end to the second end and is defined by a first edge and a second edge and parallel to the longitudinal axis. An elongated hinge is parallel to the longitudinal axis extending from the first end to the second end.

### PRIORITY CLAIM

This application claims priority to the provisional Application Ser. No. 60/493,580 filed on 7 Aug. 2003 and bearing the same title. That provisional application is incorporated by this reference.

### FIELD OF THE INVENTION

This invention relates generally to insulation technology and, more specifically, to sheathing insulation.

### BACKGROUND OF THE INVENTION

Metal has proven a very good material from which to form pipes. Ductile and rigid, pipes of iron, steel, copper or alloy prove to be easy to form and well suited for most applications. With their vast temperature ranges, metal pipes prove suitable as ducts for numerous applications.

Metal pipes, however, tend also, however, to be conductive allowing convective heating and cooling of refrigeration gasses, heated liquids or steam they carry. Often insulation is necessary to prevent the loss or gain of energy as the liquids or steam traverses lengths of pipe between heating and application. Generally, effective insulation includes a delicate structure for entrapping cells of air such as fiberglass batting, cellular foam, calcium silicate, and cellular glass. The delicate and porous nature of such insulation requires shielding to provide protection from damage such as by pipe hangers and other environmental hazards to the insulation.

Traditionally shields are formed of sheet metal tooled to conform to the exterior of the insulation in place around the pipe. Forming such sheet metal shields is time consuming, expensive, and may prevent work adjacent to the pipes in question. Preformed metal shields tend to be expensive, delicate, and difficult to ship to an installation site without damage to the metal shields.

What is needed in the art is a pipe insulation shield that is preformed, inexpensive, and easily shipped to sites without damage or undue expense.

### SUMMARY OF THE INVENTION

An insulation shield for covering insulation disposed about a pipe includes an elongated body extending along a longitudinal axis between a first end and a second end. The elongated body includes a cylindrical tube wall extending along the longitudinal axis between the first end and the second end. The tube wall has an outer surface and an inner surface. The inner surface defines an elongated channel adapted to receive pipe insulation tubing. A slit extends from the first end to the second end and is defined by a first edge and a second edge and parallel to the longitudinal axis. An elongated hinge is parallel to the longitudinal axis extending from the first end to the second end.

In accordance with other aspects of the invention, the pipe insulation shield may advantageously be formed of plastic, thereby having a number of advantages over conventional sheet metal shields. The formed plastic pipe insulation shield does not have sharp edges, it is lightweight, it is easily manufactured in various sizes and shapes at low cost, it is rust proof, it is electrically non-conductive, it has a lower thermal conductivity, and it is more flexible.

In accordance with other aspects of the invention, Because it is of a hinged, foldable construction, it has a number of other advantages. Thus, it may be stored and shipped in unfolded and stacked condition, it is easily assembled and disassembled, it is adjustable, etc. Again, all of that make it more easily, safely and efficiently installed.

As will be readily appreciated from the foregoing summary, the invention provides a preformed, inexpensive, and that is easily shipped to sites without damage or undue expense.

### BRIEF DESCRIPTION OF THE DRAWINGS

The preferred and alternative embodiments of the present invention are described in detail below with reference to the following drawings.

FIG. 1 is a perspective view of the inventive pipe in a first secured position and in alternatively in an open position;

FIG. 2 is a detail view of a living hinge;

FIG. 3 is a preferred embodiment of a latching mechanism;

FIG. 4 is an alternate embodiment of the latching mechanism that allows for engagement in a first position or alternatively in a second position;

FIG. 5 is a second alternative embodiment of the latching mechanism; and

FIG. 6 is a third alternative embodiment of the latching mechanism.

### DETAILED DESCRIPTION OF THE PREFERRED EMBODIMENT

By way of overview, an insulation shield for covering insulation disposed about a pipe includes an elongated body extending along a longitudinal axis between a first end and a second end. The elongated body includes a cylindrical tube wall extending along the longitudinal axis between the first end and the second end. The tube wall has an outer surface and an inner surface. The inner surface defines an elongated channel adapted to receive pipe insulation tubing. A slit extends from the first end to the second end and is defined by a first edge and a second edge and parallel to the longitudinal axis. An elongated hinge is parallel to the longitudinal axis extending from the first end to the second end.

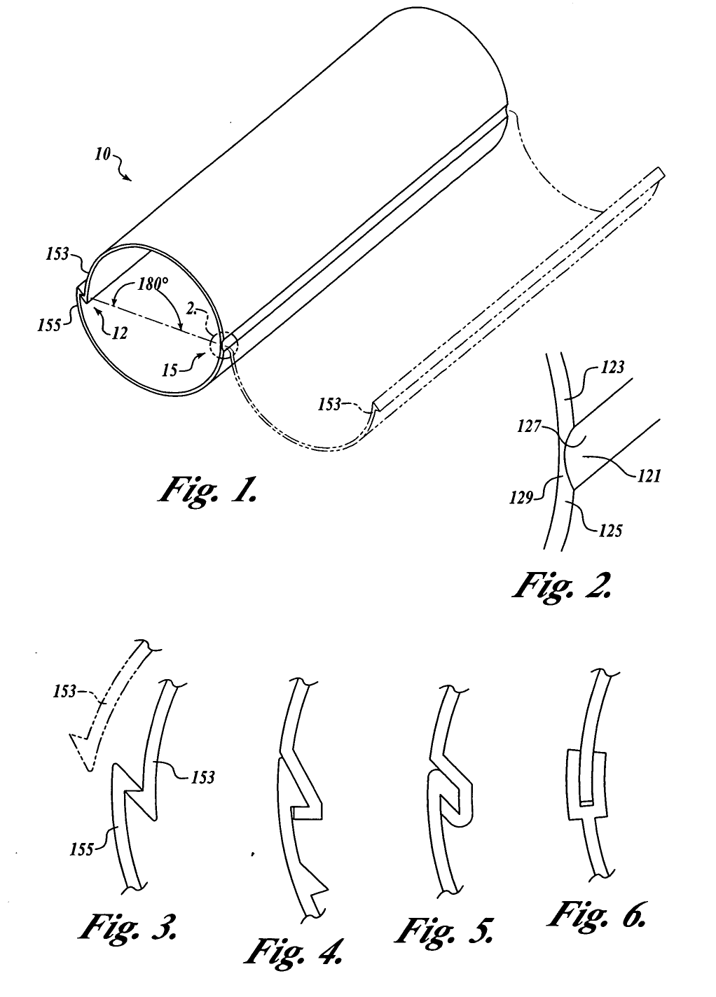

Referring to FIGS. 1 and 2, a perspective view of an inventive pipe shield 10 includes a detail view of an exemplary living hinge 15. The pipe shield 10 may be advantageously fabricated of a plastic suitable for the particular application intended. Generally, the pipe shield 10 may advantageously be formed of polyolefin polymer, nylon, polyvinyl chloride (PVC), polypropylene, polyurethane, polyethylene, rigid PVC half pipes connected by strong flexible polyurethane elastomer, or other suitable plastic material to suitably provide vapor barrier and insulation protection.

In environments were electrical or radiation shielding is necessary such as for shielding signal wiring rather than pipes, the shield may be formed of metals such as lead, copper, or aluminum. Alternatively, the shield may be advantageously formed of a plastic suitable to the applications and include either a metal foil or metal plating to provide shielding.

The pipe insulation shield 10 includes a first cylinder segment 123, a second cylinder segment 125 resiliently attached to the first cylinder segment 123 by a hinge 15. The hinge 15 is configured to allow the first cylinder segment 123 to be pivoted from an opposed cylindrical relationship to a side-by-side configuration of the pipe insulation shield 10 to allow for stacked disposition of multiple pipe insulation shields 10.

In a presently preferred embodiment, a living hinge 15 joins the first cylinder segment 123 and the second cylinder segment 125. The living hinge 15 is advantageously formed in manufacture. For example, the hinged joint may be formed during the molding process by reducing the thickness of the plastic form at the folding point to form the living hinge, which is also known as a pinless plastic utility hinge. Other types of hinge structures may also be used. Among the other hinge types which may be used are continuous hinge, geared hinge, lift-off multipurpose hinge, surface hinge, utility hinge, cabinet hinge, back flap hinge, plastic butt hinge, bifold-door hinge, and strap hinge structures.

Referring to FIG. 2, an optional coining of the material will advantageously form a coining face 127 allowing flexure of the living hinge 15 at a hinging area 121. Coining occurs when the material is held captive within a die. The die squeezes the workpiece under very high pressure causing the workpiece material to flow into a die depression resulting in a bridging section 129 of plastic or suitable material that connects the first half pipe 123 to the second half pipe 125 allowing the flexing of the providing a vapor-proof seal. The strain induced in the material is greater than the yield stress of the material plastically forming the hinge.

Referring again to FIG. 1, a mating assembly 12 includes a first interlocking longitudinal rib 153 configured to mate with a second interlocking longitudinal rib 155. In one presently preferred embodiment, the latching assembly is configured to sealing interlocking longitudinal rib 153 to interlocking longitudinal rib 155 under opposing bias forces provided either by the living hinge 15 or by the expansive forces of enclosed insulation presses against an inner surface of the first cylinder segment 123 and second cylinder segment 125.

The cylinder segment 123 and the second cylinder segment 125 are fused to the living hinge 15 in clamshell relation such that the first cylinder segment 123 is free to rotate about the hinging area 121 in relationship to the second pipe sector by substantially 180°. The rotation of the first pipe sector 123 in relation to the second pipe sector 125 from a closed position wherein the first interlocking longitudinal rib 153 is engaged with a second interlocking longitudinal rib 155 in locking relationship to an open position or alternate position shown in FIG. 1. In a presently preferred embodiment, the living hinge 15 provides a biasing force tending to move the first cylinder segment 123 toward the open position in relation to the second cylinder segment 125. The biasing force advantageously draws the first interlocking longitudinal rib 153 into locking engagement with the second interlocking longitudinal rib 155.

Each of the first pipe sector 123 and the second pipe sector 125 is configured to enclosingly receive an insulation covering a pipe by its outer surface when placed in opposed relationship. Advantageously, the first cylinder segment 123 and the second cylinder segment 125 provide a protective outer covering to insulation and is well configured to engage encircling hanging hardware encircling an outer surface of the shielding with damage to the insulation it encloses.

Referring to FIG. 3, the mating assembly 12 includes a first interlocking longitudinal rib 153 configured to mate with a second interlocking longitudinal rib 155. Longitudinal ribs are located on an inner surface of the first interlocking longitudinal rib 153 to engage longitudinal ribs on an outer surface of the second interlocking longitudinal rib 155.

Referring to FIG. 4, the first interlocking longitudinal rib 153 is a snap tabs and the second interlocking longitudinal rib 155 is a locking tab configured to form a cantilevered mating device 12 formed during the molding process. Referring to FIG. 5, the first interlocking longitudinal rib 153 Other types of mating devices may also be used. Among the other types of mating devices that may be used are positive-locking hook latch, snap slide latch, spring clip holder, plastic snap rivets, plastic removable rivets, push-in panel rivets, keyhole panel rivets, panel rivets, ratchet rivets, and tree rivets fasteners. Once the pipe insulation shield 10 is in the desired location enclosing the pipe and insulation, the first cylinder segment 123 and the second cylinder segment 125 are then folded together completely until all the fastening devices have engaged.

Referring to FIG. 6, in some instances the mating assembly is configured such that a female receptacle is formed in the edge of the second cylinder segment 125 to receive the edge of the first cylinder segment 123 in sliding engagement. Advantageously the female receptacle limits the sliding engagement to prevent crushing of enclosed insulation. Encircling clamps may advantageously secure the first cylinder segment 123 within female receptacle providing compressive biasing forces to secure the mating assembly 12.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A shield for enclosing insulation disposed to enclose a pipe comprises:
a segmented substantially tubular shell having an inner surface, an outer surface, and a principal axis including:
a first segment having a constant first sector cross-section, a first hinge edge, and a first mating edge and
a second segment having a constant second sector cross-section, a second hinge edge and a second mating edge, the second mating edge configured to engage the first mating edge in detachable attachment in a first position;
an elongate hinge joins the first segment at the first hinge edge and the second segment at the second hinge edge along a pivot axis parallel to the principal axis, the hinge configured to allow rotation of the first segment about the pivot axis from the first position to a second position through an arc of about 180 degrees.

2. The shield of claim 1, wherein the first mating edge includes at least one first ridge on the inner surface, the first ridge being arranged parallel to the principal axis, and the second mating edge includes at least one second ridge on the outer surface, the second ridge being arranged parallel to the principal axis and being configured to engage the at least one first ridge in detachable attachment when in the first position.

3. The shield of claim 2 wherein the first ridge is triangular in cross-section.

4. The shield of claim 3, wherein the second ridge is triangular in cross-section.

5. The shield of claim 1, wherein the hinge is a living hinge.

6. The shield of claim 1, wherein the first mating edge is a male edge and the second mating edge is a female edge and the second mating edge is configured to receive the first mating edge in sliding engagement.

7. The shield of claim 1, wherein the shield is constructed out of a molded plastic material as a unitary member.

8. A molded, unitary, snap-fit enclosing shield for placement around insulation of a pipe comprises:
top and bottom enclosing portions which are hingedly joined together and moveable into an enclosing form;
first snap-fit means extending from the bottom enclosing portion for providing one part of a two-part snap-fit assembly; and
second snap-fit means extending from the top enclosing portion for providing the second part of snap-fit assembly.

9. The shield of claim 8, wherein the first snap-fit means include a male engaging surface.

10. The shield of claim 9, wherein the second snap-fit means include a female engaging receptacle.

11. The shield of claim 10, wherein the male engaging surface is moved into alignment with the female receptacle when the top enclosing portion is rotated into an engaging orientation with the bottom enclosing portion.

12. An insulation shield for covering insulation disposed about a pipe, the shield comprising:
an elongated body extending along a longitudinal axis between a first end and a second end, the elongated body including;
a cylindrical tube wall extending along the longitudinal axis between the first end and the second end, the tube wall having an outer surface and an inner surface defining an elongated channel adapted to receive pipe insulation tubing;
a slit extending from the first end to the second end, defined by a first edge and a second edge, and parallel to the longitudinal axis; and
an elongated hinge parallel to the longitudinal axis extending from the first end to the second end.

13. The shield of claim 12, wherein the inner surface defines a center bore extending longitudinally between the first and second ends adapted to receive an elongated cylindrical pipe encapsulated by the pipe insulation tubing therethrough.

14. The shield of claim 12, wherein the elongated body includes a first generally C-shaped clam shell portion and a second generally C-shaped clam shell portion.

15. The shield of claim 14, wherein the elongate hinge includes a living hinge interconnecting the first and second clam shell portions longitudinally between the first and second ends for pivoting the clam shell portions from an open position adapted to receive the pipe and pipe insulation tubing and a closed position coupled about the pipe and adjacent ends of the pipe insulation tubing.

16. The shield of claim 12, wherein the shield is formed of plastic.

17. The shield of claim 12, wherein the shield is blow molded.

18. The shield of claim 12, wherein first edge is configured to engage the second edge in detachable attachment.

19. The shield of claim 18, wherein:
at least one first longitudinal rib is disposed parallel to the longitudinal axis on the inner surface substantially at the first edge; and
at least one second longitudinal rib is disposed parallel to the longitudinal axis on the outer surface substantially at the second edge, the second longitudinal rib configured to engage the first longitudinal rib in detachable attachment.

20. The shield of claim 18, wherein the second edge includes a female receptacle disposed parallel to the longitudinal axis and configured to engage a male tab extending from the first edge in detachable attachment.
